(19) United States
(12) Patent Application Publication
(10) Pub. No.: US 2010/0163590 A1
(43) Pub. Date: Jul. 1, 2010

(54) Receiver Hitch Modification

(76) Inventor: Mark McCaughan, Anacortes, WA (US)

Correspondence Address: Mark McCaughan, 4820 woodside dr., Anacortes, WA, 98221, US

(21) Appl. No.: 12/345,555

(22) Filed: Dec. 29, 2008

(51) Int. Cl. B60R 9/00

(52) U.S. Cl. 224/521

(57) ABSTRACT

A receiver hitch modification for hauling cargo behind a vehicle and configured to mount on a hitch is disclosed. The invention embodies a coupling device interposed between a receiver hitch and a cargo hauler which allows rotation of the hauler left or right and thereby allows a heavy load to slide on to the hauler instead of having to be lifted from the ground up to the bed of the hauler. The receiver hitch includes a base, a frame pivotally mounted the base, and a basket rotatably supported on the frame. The frame is pivoted between loading and transport positions. The basket is rotatable substantially 180 degrees relative to the frame and can maintain indexed positions of rotation.

### FIELD OF THE INVENTION

This invention relates to improvements in hitch connections for trailers and more particularly, but not by way of limitation, to a swivel connection for cargo haulers.

It is often desirable to haul certain kinds of cargo behind a passenger vehicle, particularly where the inside of the vehicle is not well suited for hauling the cargo (e.g., hauling a deer carcass, firewood, oversized furniture, etc., in a sedan or sport utility vehicle). The cargo is often difficult to load (e.g., heavy) and it is desirable for the hauler to facilitate both the loading of the cargo and stowing the cargo for transport. It is also desirable for the hauler to be easily removable from the vehicle, as well as allow access to the rear compartment of the vehicle while the hauler is attached (e.g., to facilitate loading cargo into a truck bed).

Prior art hauling devices include wheeled carts that are towed behind a vehicle or devices permanently affixed to the vehicle. These prior art devices present undesirable limitations. For example it is typically difficult to manually load heavy objects (e.g., motorized scooter, etc.) in these devices and such devices can impede access to the rear of the passenger vehicle.

Similarly, trailers have been provided with a hinged ramp such as that shown in U.S. Pat. No. 4,032,167, but the ramps do not have a floor next to them so that there is a substantial hazard as the user rides up the ramp to the floor of the trailer. Ramps of the type shown in U.S. Pat. No. 4,032,167, and particularly, present a problem with contacting the frame or exhaust pipes of a motorcycle as the motorcycle passes over this angle between the ramp and the floor of the trailer. Trailers with tilting floors have been used for many years and two patents showing such trailers are U.S. Pat. Nos. 4,813,841 and 5,016,896.

### SUMMARY

The present invention allows rotation of receiver hitch cargo haulers to enable easy loading of heavy items. The invention embodies a coupling device interposed between a receiver hitch and a cargo hauler which allows rotation of the hauler left or right and thereby allows a heavy load to slide on to the hauler instead of having to be lifted from the ground up to the bed of the hauler.

The present invention provides an improved hauler that does not suffer from the problems and limitations of prior art hauling devices set forth above. The inventive hauler provides a hauler that mounts on the hitch (e.g., a receiver hitch) of a passenger vehicle for easy removal. The hauler is pivotable between loading and transport positions to facilitate the loading and hauling of cargo.

The hauler of the present invention broadly includes a slide base operable to mount on a hitch, a frame pivotally supported on the base, and locking pins to allow a basket or bike rack, motorcycle rack etc. rotatably supported on the frame and being operable to haul cargo. The frame is pivotable between a loading position, wherein the attached device is adjacent the ground and a transport position, wherein the basket is spaced from the ground and adjacent the rear of the vehicle. The attached device is rotatable into a plurality of various, indexed, rotational positions relative to the frame.

In operation, the base may be mounted to a hitch of a passenger vehicle so that the frame is supported behind the rear of the vehicle. The cargo-loaded device may then be rotated into an upright position and the frame may be pivoted into the transport position where it may be locked to facilitate the transport of the cargo.

### BRIEF DESCRIPTION OF THE DRAWINGS

FIG. 1 is a frontal top perspective of the device

FIG. 2 is a frontal top perspective of the device with cargo pan

### DESCRIPTION OF THE PREFERRED EMBODIMENT

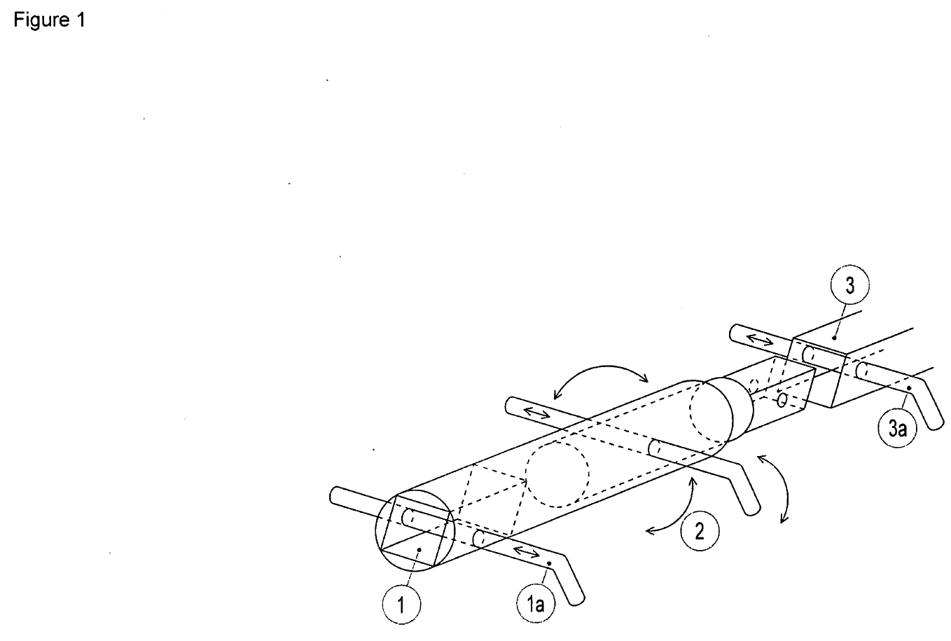

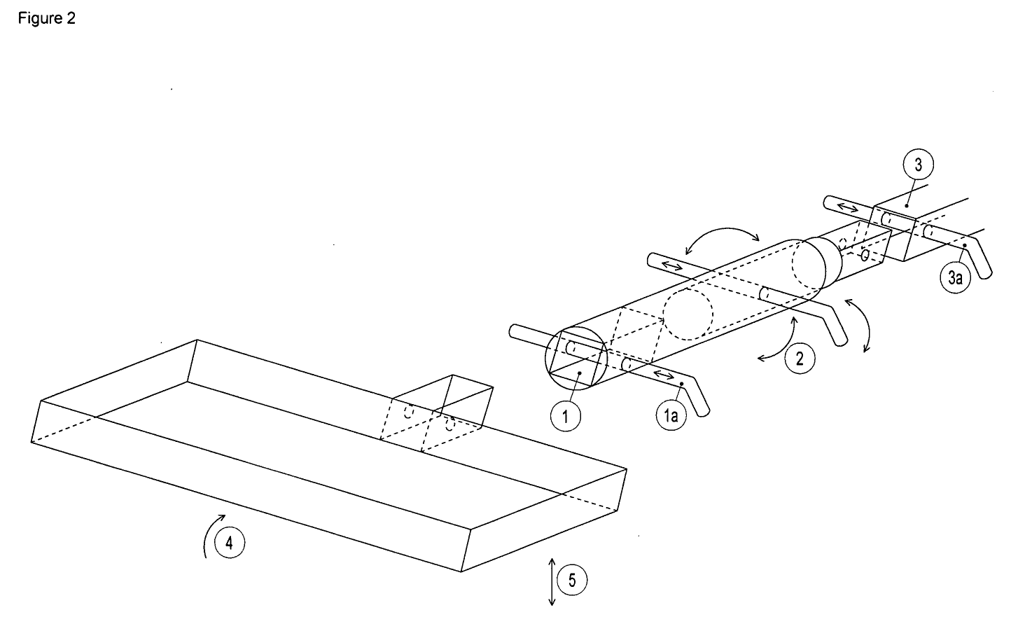

FIG. 1: #1—device to be hitched attaches here and is fixed in place by removeable pin 1A. #2—removing this pin allows the rotating hitch adapter to be moved in a clockwise or counterclockwise direction. #3—vehicle receiver hitch-locked in place by removeable pin 3A. FIG. 2: #4—an example of a device to be placed into the hitch adapter. #1—vehicle's receiver hitch. #5—by removing pin #2 the rotating hitch adapter may be rotated clockwise or counterclockwise thus allowing either end of the device used in this example to be lowered to the ground for easy loading of heavy or cumbersome loads.

What is claimed is:

1. A receiver hitch modification device mounted onto a cargo pan or platform comprised of;
a. rotating hitch adapter
b. removable pin
c. hitch adapter
d. a female receiving hitch

2. A receiver hitch modification device according to claim 1 wherein; the receiver embodies a square male hitching point.

3. A receiver hitch modification device according to claim 1 wherein; the receiver embodies a square female hitching point

4. A receiver hitch modification device according to claim 1 wherein; the receiver embodies tubular male hitching point

5. A receiver hitch modification device according to claim 1 wherein; the receiver embodies a tubular female hitching point

6. A receiver hitch modification device according to claim 1 wherein; the device is permanently mounted to the cargo tray.

7. A receiver hitch modification device according to claim 1 wherein; the device is temporarily mounted to the cargo tray
